(19) United States
(12) Patent Application Publication
(10) Pub. No.: US 2026/0339882 A1
(43) Pub. Date: Oct. 29, 2026

(54) System and Method for Physical Disaggregation of Memory and Compute in Large Language Model Serving

(71) Applicant: TurboNext.ai Ltd., Singapore (SG)

(72) Inventors: Rolf Muralt, Palo Alto, CA (US); Shang-Tse Chuang, Taipei (TW); Sharad Vasantrao Chole, San Mateo, CA (US); Costas Calamvokis, Bath (GB); Siyad Chih-Hua Ma, Palo Alto, CA (US); Joonsuk Bae, Menlo Park, CA (US); Kevin Lin, San Jose, CA (US)

(21) Appl. No.: 19/648,861

(22) Filed: Apr. 15, 2026

Related U.S. Application Data
(60) Provisional application No. 63/795,120, filed on Apr. 25, 2025.
(60) Provisional application No. 63/795,128, filed on Apr. 25, 2025.
(60) Provisional application No. 63/795,138, filed on Apr. 25, 2025.

(51) Int. Cl. G06F 15/173; G06F 13/42

(52) U.S. Cl. CPC G06F 15/173; G06F 13/4282

(57) ABSTRACT

A system for serving a large language model physically disaggregates compute and memory resources across separate accelerator cards. First accelerator cards store weight parameters in a first memory and perform compute-bound operations. Second accelerator cards, physically separate from the first accelerator cards, store session-specific state including a key-value cache in a second memory and perform memory-bound operations. An interconnection mechanism connects the cards, transferring only compact intermediate activation vectors during each decode iteration. The second accelerator cards may include application-specific integrated circuit packages with chiplets integrating processing cores, memory channels, and interfaces. A software abstraction layer integrated with an inference framework distributes workload across heterogeneous hardware. The second accelerator cards may be configured as linecards in a modular network switch chassis with a non-blocking backplane.

### CROSS-REFERENCE TO RELATED APPLICATIONS

This application claims the benefit and priority of U.S. Provisional Application No. 63/795,120, filed Apr. 25, 2025, entitled "System and Method for Physical Disaggregation of Memory and Compute in Large Language Model Serving," U.S. Provisional Application No. 63/795,128, filed Apr. 25, 2025, entitled "Transformer LLM Disaggregation for Heterogeneous Processing Units," and U.S. Provisional Application No. 63/795,138, filed Apr. 25, 2025, entitled "Distributed Processing of Large Language Models and Other Neural Network Workloads Using a Modular, Dynamically Reconfigurable Interconnection Fabric," each of which is hereby incorporated by reference herein in its entirety including all references and appendices cited therein, for all purposes, as if fully set forth herein.

This application is also related to U.S. Patent Application No. 19/647,709, filed Apr. 14, 2026, entitled "Transformer LLM Disaggregation for Heterogeneous Processing Units," and U.S. Patent Application No. [__/__,___], filed [DATE], entitled "Distributed Processing of Large Language Models and Other Neural Network Workloads Using a Modular, Dynamically Reconfigurable Interconnection Fabric," each of which is hereby incorporated by reference herein in its entirety including all references and appendices cited therein, for all purposes, as if fully set forth herein.

### FIELD

The present disclosure relates to systems and architectures for serving Large Language Models, and more particularly to physically disaggregated compute and memory architectures that assign compute-bound and memory-bound inference operations to separate accelerator cards, including but not limited to graphics processing unit (GPU) cards, neural processing unit (NPU) cards, language processing unit (LPU) cards, and other specialized accelerator cards.

### BACKGROUND

Large Language Models support a variety of artificial intelligence applications, including conversational chatbots, enterprise retrieval-augmented generation systems, text summarization tools, and knowledge-based query platforms. Serving these models at scale demands significant computational resources during inference. In conventional deployments, inference workloads are handled by clusters of graphics processing unit accelerators such as the NVIDIA H100. In a typical configuration, both the trained model weight parameters and the per-session key-value caches are stored in in-package high -bandwidth memory on the same graphics processing unit, and both the compute-bound feed-forward operations and the memory-bound attention operations execute on that same chip.

This co-located architecture encounters substantial limitations as the number of concurrent inference sessions grows. High bandwidth memory is expensive, costing approximately twenty to thirty dollars per gigabyte compared to approximately two to three dollars per gigabyte for commodity double data rate memory. A current-generation graphics processing unit accelerator provides approximately one hundred forty-one gigabytes of high bandwidth memory. For a seventy-billion-parameter model in sixteen-bit floating-point format, the weight parameters alone consume approximately one hundred forty gigabytes, leaving minimal capacity for key-value cache storage. Yet the key-value cache grows linearly with context length and is unique to each session. A typical multi-turn chatbot workload with context windows of four thousand to eight thousand tokens requires approximately 2.7 gigabytes of key-value cache per session. Serving one million concurrent users with such a model produces an aggregate key-value cache demand of approximately 2.7 petabytes, an amount that exceeds the total high bandwidth memory capacity of any practical graphics processing unit fleet by orders of magnitude.

Existing systems address this memory shortfall through one of two strategies, both of which degrade performance. In a first strategy, the system flushes inactive key-value cache entries and recomputes them from scratch when the corresponding sessions are reactivated. Recomputation requires a full prefill pass through every Transformer layer, consuming graphics processing unit cycles that could otherwise serve active sessions and increasing time-to-first-token latency beyond acceptable thresholds for interactive applications. In a second strategy, the system moves inactive key-value cache data to slower tiers, such as server-hosted double data rate (DDR) dynamic random-access memory or solid-state drives, and pages the data back into high bandwidth memory when needed. This tiered approach introduces data movement overhead, consumes interconnect bandwidth, and increases energy consumption proportionally with session churn. Both strategies become increasingly impractical as context windows grow longer and as applications such as retrieval-augmented generation and document summarization demand larger per-session key-value caches.

Furthermore, conventional graphics processing unit accelerators are architected for compute-heavy training workloads and are poorly matched to the memory-bound nature of autoregressive inference. During the decode phase of token generation, each Transformer layer requires a full read of the key-value cache tensors but performs relatively little arithmetic, resulting in low utilization of the graphics processing unit matrix engines. The hardware is thus simultaneously memory-starved and compute-underutilized, a mismatch that wastes both capital expenditure and energy at datacenter scale.

### SUMMARY

In accordance with one aspect, a system for serving a Large Language Model includes one or more first accelerator cards configured to store weight parameters of the Large Language Model in a first memory and to perform compute-bound operations of the Large Language Model, one or more second accelerator cards, physically separate from the one or more first accelerator cards, configured to store session-specific state including a key-value cache in a second memory distinct from the first memory and to perform memory-bound operations of the Large Language Model, and an interconnection mechanism connecting the one or more first accelerator cards and the one or more second accelerator cards.

In some embodiments, the one or more second accelerator cards store the session-specific state in commodity double data rate (DDR) dynamic random-access memory. In some embodiments, only intermediate activation vectors are transferred between the one or more first accelerator cards and the one or more second accelerator cards via the interconnection mechanism, and the key-value cache remains resident on the one or more second accelerator cards. In some embodiments, the interconnection mechanism includes at least one of a Peripheral Component Interconnect Express bus, an Ethernet network, or an InfiniBand network. In some embodiments, the one or more first accelerator cards and the one or more second accelerator cards are installed in physically separate chassis. In some embodiments, a software abstraction layer decouples model placement from a specific accelerator card type, and the one or more first accelerator cards include accelerator cards from different vendors or different generations. In some embodiments, a number of the one or more second accelerator cards is independently scalable from a number of the one or more first accelerator cards.

In accordance with another aspect, a system includes one or more first accelerator cards, each first accelerator card comprising a first memory storing weight parameters of a Large Language Model, one or more second accelerator cards, physically separate from the one or more first accelerator cards, each second accelerator card comprising a second memory, distinct from the first memory, storing session-specific state including a key-value cache, and an interconnection mechanism connecting the one or more first accelerator cards and the one or more second accelerator cards and configured to transfer intermediate activation vectors between the one or more first accelerator cards and the one or more second accelerator cards. The one or more first accelerator cards are configured to perform compute-bound operations using the weight parameters, and the one or more second accelerator cards are configured to perform memory-bound operations using the session-specific state.

In some embodiments, the session-specific state remains resident on the one or more second accelerator cards and does not traverse the interconnection mechanism. In some embodiments, the system iteratively executes, for each output token of the Large Language Model, the compute-bound operations on the one or more first accelerator cards, the memory-bound operations on the one or more second accelerator cards, and a transfer of the intermediate activation vectors via the interconnection mechanism. In some embodiments, a software abstraction layer is integrated with an inference framework and is configured to distribute workload between the one or more first accelerator cards and the one or more second accelerator cards. In some embodiments, the one or more first accelerator cards include accelerator cards from different vendors or different generations. In some embodiments, storing the session-specific state on the one or more second accelerator cards eliminates eviction and recomputation of the key-value cache as a number of concurrent inference sessions increases. In some embodiments, the one or more second accelerator cards store a prefix cache representing a shared initial key-value cache state computed from a common prompt prefix, the prefix cache being shared across multiple concurrent inference sessions without recomputation.

In accordance with yet another aspect, a method for serving the Large Language Model includes storing weight parameters of the Large Language Model on one or more first accelerator cards, storing session-specific state including a key-value cache on one or more second accelerator cards physically separate from the one or more first accelerator cards, performing compute-bound operations of the Large Language Model on the one or more first accelerator cards using the weight parameters, performing memory-bound operations of the Large Language Model on the one or more second accelerator cards using the session-specific state, and transferring intermediate activation vectors between the one or more first accelerator cards and the one or more second accelerator cards via an interconnection mechanism. The session-specific state remains resident on the one or more second accelerator cards.

In some embodiments, the method further includes iteratively executing, for each output token of the Large Language Model, the compute-bound operations, the memory-bound operations, and the transfer of the intermediate activation vectors, and generating the output token based on results of the compute-bound operations and the memory-bound operations. In some

embodiments, the one or more second accelerator cards store the session-specific state in commodity double data rate (DDR) dynamic random-access memory. In some embodiments, the feed-forward calculations and the attention calculations are distributed across the one or more first accelerator cards and the one or more second accelerator cards via a software abstraction layer, and the one or more first accelerator cards include accelerator cards from different vendors or different generations. In some embodiments, a prefix cache is stored on the one or more second accelerator cards, the prefix cache representing a shared initial key-value cache state computed from a common prompt prefix and shared across multiple concurrent inference sessions without recomputation. In some embodiments, each second accelerator card includes a plurality of application-specific integrated circuit packages, each application-specific integrated circuit package including chiplets that integrate a processing core, a Peripheral Component Interconnect Express interface, and a plurality of memory channels.

### BRIEF DESCRIPTION OF THE DRAWINGS

FIG. 1 is a block diagram of a system for serving a Large Language Model showing a disaggregated architecture with first accelerator cards and second accelerator cards connected by an interconnection mechanism, according to an embodiment.

FIG. 2 is a schematic block diagram of a second accelerator card showing application-specific integrated circuit packages, chiplets, and memory channels, according to an embodiment.

FIG. 3 is a system data flow diagram of a decode iteration showing the flow of weight parameters, key-value cache data, and intermediate activation vectors during token generation, according to an embodiment.

FIG. 4 is a block diagram of a chassis and a modular network switch chassis integration showing first accelerator cards and second accelerator card linecards in physically separate enclosures, according to an embodiment.

FIG. 5 is a block diagram of a software abstraction layer and interconnection types showing workload distribution across heterogeneous first accelerator cards and a second accelerator card, according to an embodiment.

FIG. 6 is a flowchart of a method for serving a Large Language Model showing the steps of storing weight parameters and key-value cache data, performing feed-forward and attention calculations, transferring intermediate activation vectors, and iteratively generating output tokens, according to an embodiment.

FIG. 7 is a schematic diagram of an example computer system that can be used in embodiments of the present disclosure.

### DETAILED DESCRIPTION OF EXAMPLE EMBODIMENTS

The following description provides example embodiments of systems for serving a Large Language Model using a physically disaggregated architecture in which compute-bound operations and memory-bound operations are assigned to separate hardware resources. Although specific configurations, memory types, interconnection technologies, and form factors are described, these details are provided as examples and are not intended to limit the scope of the claims. Various modifications and alternative arrangements will be apparent to those of ordinary skill in the art.

As used herein, the term "first accelerator card" refers to any accelerator card, compute module, or integrated-circuit package optimized for compute-bound operations and having characterizable resource attributes including arithmetic throughput and memory bandwidth. Non-limiting examples of first accelerator cards include graphics processing unit (GPU) cards such as the NVIDIA H100, NVIDIA A100, or AMD Instinct MI325X. As used herein, the term "second accelerator card" refers to any accelerator card, compute module, or integrated-circuit package optimized for memory-bound operations and having characterizable resource attributes including memory capacity and memory bandwidth. Non-limiting examples of second accelerator cards include neural processing unit (NPU) cards, language processing unit (LPU) cards, field-programmable gate array (FPGA) cards, tensor processing unit (TPU) cards, and custom application-specific integrated circuit (ASIC) cards.

The claims are not limited to any particular type or commercial designation of accelerator card, and any accelerator card or compute device having characterizable resource attributes falls within the scope of these terms. Throughout the detailed description, GPU cards and NPU cards are used as representative, non-limiting examples of first accelerator cards and second accelerator cards, respectively. As used herein, "first memory" refers to any memory technology co-packaged with or locally attached to the first accelerator card and characterized by high bandwidth relative to capacity. Non-limiting examples of first memory include high-bandwidth memory (HBM), including HBM2, HBM2e, HBM3, and HBM3e, as well as graphics double data rate (GDDR) memory. As used herein, "second memory" refers to any memory technology attached to or accessible by the second accelerator card and characterized by high capacity at lower cost per byte relative to the first memory. Non-limiting examples of second memory include double data rate (DDR) dynamic random-access memory, low-power double data rate (LPDDR) memory such as LPDDR5, and other commodity dynamic random-access memory.

As used herein, "compute-bound operations" includes all linear transformations of the large language model that are dominated by arithmetic throughput rather than by memory bandwidth, including but not limited to feed-forward network layers, query-key-value projection layers, output projection layers, and any other weight-matrix multiplication operations. As used herein, "memory-bound operations" includes all operations of the large language model that are dominated by memory bandwidth rather than by arithmetic throughput, including but not limited to attention score computation, softmax normalization, and weighted summation of value vectors referencing session-specific cached state.

As used herein, "session-specific state" refers to any data generated during inference that is unique to an individual user session and that grows with the length of the session context. Non-limiting examples of session-specific state include key-value caches storing previously computed key vectors and value vectors for each Transformer layer, attention state, per-session context embeddings, and reasoning-chain intermediate tokens. As used herein, "processing core" refers to the computational logic within a chiplet or integrated-circuit package that executes the assigned operations on the second accelerator card. Non-limiting examples of processing cores include neural processing unit cores, inference accelerator cores, tensor processing cores, FPGA fabric configured for matrix operations, and any other digital logic optimized for the memory-bound workload profile of the second accelerator card.

As used herein, "interconnection mechanism" refers to any communication link, bus, fabric, or network coupling the first accelerator cards and the second accelerator cards. Non-limiting examples of interconnection mechanisms include Peripheral Component Interconnect Express (PCIe) buses, Ethernet networks (including Remote Direct Memory Access (RDMA) over Converged Ethernet), InfiniBand networks, NVLink connections, CXL (Compute Express Link) interconnects, proprietary chip-to-chip links, and any combination thereof.

Conventional Large Language Model serving architectures employ homogeneous graphics processing unit clusters in which every graphics processing unit stores both the trained model weight parameters and the per-session key-value caches in in-package high bandwidth memory. Both the compute-bound feed-forward calculations and the memory-bound attention calculations execute on the same physical chip. Pipeline parallelism and tensor parallelism distribute state and compute equally across identical graphics processing units, creating lock-step execution where every graphics processing unit in the pipeline is equally capable for the entire model. When high bandwidth memory capacity is exhausted, conventional systems either flush inactive key-value caches and recompute them upon reactivation, or swap key-value cache data to server-hosted double data rate (DDR) dynamic random-access memory or solid-state drive tiers. Both approaches introduce latency, energy waste, and cost at scale. The embodiments described herein address these limitations by physically separating compute resources from memory resources across distinct accelerator cards, introducing an additional dimension of parallelism that is orthogonal to existing pipeline and tensor parallelism axes.

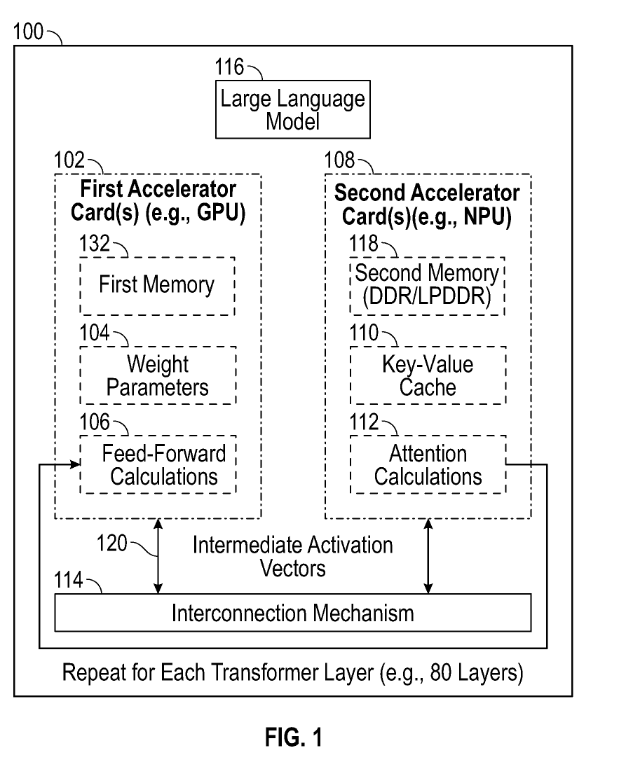

Referring to FIG. 1, a system 100 for serving a Large Language Model 116 is shown. The system 100 comprises one or more first accelerator cards 102 (in this embodiment, graphics processing unit (GPU) cards) configured to store weight parameters 104 and perform feed-forward calculations 106, one or more neural processing unit (NPU) cards 108, physically separate from the one or more first accelerator cards 102, configured to store a key-value cache 110 and perform attention calculations 112, and an interconnection mechanism 114 connecting the one or more first accelerator cards 102 and the one or more second accelerator cards 108. The Large Language Model 116 is distributed across the one or more first accelerator cards 102 and the one or more second accelerator cards 108 such that different portions of the Large Language Model 116 reside on different hardware resources matched to the computational characteristics of each portion. This physical disaggregation breaks the conventional assumption that the same chip handles both compute-bound and memory-bound portions of inference, and introduces workload-type parallelism as an additional axis that is orthogonal to existing pipeline and tensor parallelism techniques.

Each first accelerator card 102 comprises first memory 132 (e.g., high bandwidth memory (HBM)) storing the weight parameters 104 of the Large Language Model 116. The weight parameters 104 are the trained model parameters, including all weights and biases across every layer, of the Large Language Model 116. For a seventy-billion-parameter model in sixteen-bit floating-point format, the weight parameters 104 may require approximately one hundred forty gigabytes of storage. In a current-generation implementation, the first accelerator card 102, such as an NVIDIA H100, provides approximately eighty gigabytes of first memory 132 capacity. Because the weight parameters 104 of a seventy-billion-parameter model exceed the first memory 132 capacity available on the first accelerator card 102, two or more first accelerator cards 102 are used, as further described with reference to tensor parallel and pipeline parallel distribution below. The first memory 132 provides the bandwidth for compute-bound matrix operations performed during the feed-forward calculations 106.

The weight parameters 104 are common to all inference sessions because the trained model does not change between sessions, and thus the memory footprint of the weight parameters 104 is shared across every concurrent user served by the system 100. When the aggregate size of the weight parameters 104 exceeds the first memory 132 capacity available on the first accelerator card 102, the weight parameters 104 can be distributed across multiple first accelerator cards 102 using tensor parallel techniques, in which different portions of each weight matrix are placed on different first accelerator cards 102. In one embodiment, the weight parameters 104 of an eighty-layer Large Language Model 116 are partitioned across four first accelerator cards 102 using tensor parallelism, with each first accelerator card 102 storing approximately thirty-five gigabytes of the weight parameters 104. In an alternative embodiment, the weight parameters 104 are distributed across first accelerator cards 102 using pipeline parallelism, in which different layers of the Large Language Model 116 are assigned to different first accelerator cards 102. Both tensor parallel and pipeline parallel distribution of the weight parameters 104 are compatible with the disaggregated architecture of the system 100.

The feed-forward calculations 106 are the compute-bound linear transformation operations within each Transformer block of the Large Language Model 116. Each Transformer block comprises both an attention sub-stage and a feed-forward sub-stage. The feed-forward sub-stage applies linear layers and non-linear activations against the weight parameters 104, taxing the matrix engines of the first accelerator card 102. In a typical Transformer architecture, the feed-forward sub-stage includes a first linear projection that expands the hidden dimension, a non-linear activation function such as Sigmoid Linear Unit (SiLU), and a second linear projection that contracts the result back to the original hidden dimension. These operations involve large matrix multiplications that are compute-bound, meaning the number of floating-point operations per byte of data accessed is high. Because the feed-forward calculations 106 are compute-bound, the feed-forward calculations 106 are well-suited to the parallel processing capabilities of the first accelerator card 102 and the high-bandwidth access characteristics of the first memory 132. Assigning the feed-forward calculations 106 to the first accelerator card 102 ensures that the matrix engines of the first accelerator card 102 remain fully utilized during the feed-forward sub-stage, rather than idling during the memory-bound attention sub-stage as occurs in conventional co-located architectures. In addition to the feed-forward sub-stage, the query-key-value (QKV) projection layers that transform hidden-state vectors into query, key, and value vectors are also compute-bound weight-matrix multiplications that execute on the first accelerator card 102. The output projection layer that maps the attention output back to the hidden dimension likewise executes on the first accelerator card 102. Accordingly, the compute-bound operations assigned to the first accelerator card 102 include the feed-forward sub-stage, the QKV projection layers, and the output projection layer, while only the memory-bound attention score computation and value-weighted summation execute on the second accelerator card 108.

Continuing with FIG. 1, each second accelerator card 108 comprises second memory 118, which in this embodiment comprises commodity double-data-rate dynamic random-access memory (DDR DRAM). The one or more second accelerator cards 108 store the key-value cache 110 in the second memory 118. The second memory 118 may comprise double data rate (DDR) memory or low power double data rate (LPDDR) memory, such as LPDDR5 modules. The second memory 118 provides cost-effective, high-capacity storage at a lower cost per byte, approximately two to three dollars per gigabyte, compared to approximately twenty to thirty dollars per gigabyte for the first memory 132 on the first accelerator card 102. Each second accelerator card 108 may provide hundreds of gigabytes of second memory 118 capacity, enabling storage of key-value caches 110 for many concurrent user sessions (also referred to herein as concurrent inference sessions) without eviction. A second accelerator card 108 may provide hundreds of gigabytes of second memory 118 capacity through a combination of multiple LPDDR5 modules distributed across several chiplets on the second accelerator card 108. The commodity nature of the second memory 118, sourced from standard memory vendors, further reduces procurement cost and supply chain risk relative to the proprietary first memory 132 stacks used on first accelerator cards 102.

The key-value cache 110 comprises session-specific cached key and value tensors generated during inference. Unlike the weight parameters 104, which are common to all sessions, the key-value cache 110 contains data that is distinct to each active session. The size of each key-value cache 110 grows linearly with the length of the chat history or context window of the inference session. For a typical multi-turn chatbot workload with context windows of four thousand to eight thousand tokens, which equates to roughly two thousand English words, each session generates approximately 2.7 gigabytes of key-value cache 110 on a seventy-billion-parameter model having an embedding size of 8192, eighty Transformer layers, sixty-four attention heads, eight key-value heads, and a head size of 128. At each question-and-answer turn in the conversation, the Large Language Model 116 decode stage generates approximately two hundred new tokens, extending the key-value cache 110 for that session.

Scaling to one million concurrent sessions produces an aggregate key-value cache 110 demand of approximately 2.7 petabytes. This demand exceeds the aggregate first memory 132 capacity of even the largest conventional GPU fleets by orders of magnitude. By storing the key-value cache 110 on the one or more second accelerator cards 108 in the inexpensive second memory 118 rather than in the scarce first memory 132 on the first accelerator card 102, the system 100 provides a practical path to petabyte-scale key-value cache 110 storage while preserving the first memory 132 on the first accelerator card 102 for the compute-intensive weight parameters 104. Storing the key-value cache 110 on the one or more second accelerator cards 108 eliminates eviction and recomputation of the key-value cache 110 as a number of concurrent inference sessions increases, avoiding the latency penalty and computational cost of full prefill recomputation that afflicts conventional tiered memory architectures.

The attention calculations 112 are the memory-bound matrix multiplication operations over query, key, and value tensors within each Transformer block of the Large Language Model 116. In the Transformer architecture, the attention sub-stage computes scaled dot-product attention by multiplying query vectors against the stored key tensors to produce attention scores, then multiplying the attention scores against the stored value tensors to produce the attention output. These operations require sustained high memory bandwidth to read from and write to the key-value cache 110 in the second memory 118. For each token generated, the attention calculations 112 read the entire accumulated key-value cache 110 for that session, making the attention calculations 112 memory-bandwidth-bound rather than compute-bound. In a model with eighty Transformer layers, each decode step reads the key-value cache 110 eighty times, once per layer. The ratio of floating-point operations to bytes accessed during the attention calculations 112 is low, meaning that the processing speed is limited by how fast data can be read from memory, not by the speed of the arithmetic units.

Assigning the attention calculations 112 to the second accelerator card 108 co-located with the key-value cache 110 confines the memory-bound operations to the hardware best matched to memory-bound workload demands and minimizes cross-card data movement. The second accelerator card 108 is optimized for high memory throughput across large pools of second memory 118 rather than for the peak arithmetic throughput that characterizes first accelerator cards 102. In one embodiment, each second accelerator card 108 provides aggregate memory bandwidth across all of the second memory 118 modules that is sufficient to sustain real-time attention calculations 112 for hundreds of concurrent sessions simultaneously.

The interconnection mechanism 114 connects the one or more first accelerator cards 102 and the one or more second accelerator cards 108. The interconnection mechanism 114 carries intermediate activation vectors 120 between the one or more first accelerator cards 102 and the one or more second accelerator cards 108. The intermediate activation vectors 120 are the compact data transferred between the one or more first accelerator cards 102 and the one or more second accelerator cards 108 during each decode iteration. At each Transformer layer boundary, the output of the feed-forward calculations 106 on the first accelerator card 102 is sent as an intermediate activation vector 120 through the interconnection mechanism 114 to the second accelerator card 108 for the attention calculations 112, and the result of the attention calculations 112 is returned as an intermediate activation vector 120 through the interconnection mechanism 114 to the first accelerator card 102 for the next layer.

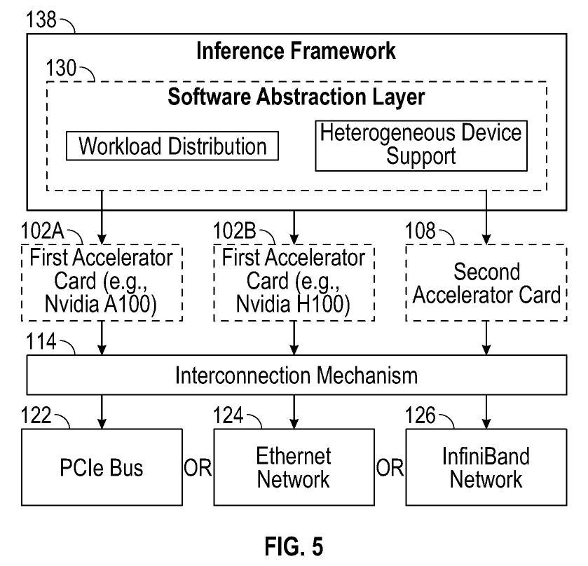

The intermediate activation vectors 120 represent kilobytes of data per token, which is roughly two orders of magnitude smaller than the bulk key-value cache 110 data that would need to be transferred in conventional architectures that stream key-value cache data between memory tiers. Because the intermediate activation vectors 120 are compact, the bandwidth demands on the interconnection mechanism 114 are modest relative to the bandwidth available on modern interconnect fabrics. In some embodiments, only the intermediate activation vectors 120 are transferred between the one or more first accelerator cards 102 and the one or more second accelerator cards 108 via the interconnection mechanism 114, and the key-value cache 110 remains resident on the one or more second accelerator cards 108 and does not traverse the interconnection mechanism 114. In such embodiments, inter-device bandwidth requirements are reduced by approximately two orders of magnitude relative to architectures that stream bulk key-value cache data for every decode step. The interconnection mechanism 114 may comprise at least one of a Peripheral Component Interconnect Express (PCIe) bus, an Ethernet network, or an InfiniBand network, as further described with reference to FIG. 5.

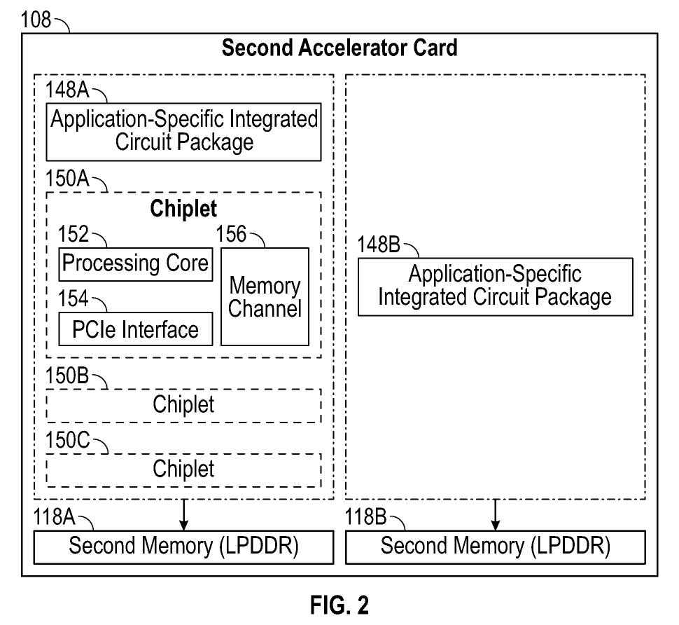

Turning to FIG. 2, the second accelerator card 108, previously described with reference to FIG. 1, is shown in greater detail. As shown in FIG. 2, the second accelerator card 108 comprises a plurality of application-specific integrated circuit packages 148A, 148B. Each application-specific integrated circuit package 148A, 148B comprises chiplets 150A, 150B, 150C that integrate a processing core 152, a Peripheral Component Interconnect Express interface 154, and a plurality of memory channels 156. The second accelerator card 108 may be implemented as a printed circuit board (PCB) on which the application-specific integrated circuit packages 148A, 148B are mounted alongside second memory 118A, 118B modules. In one embodiment, the second accelerator card 108 includes four application-specific integrated circuit packages, of which the application-specific integrated circuit packages 148A, 148B are representative, providing a dense array of processing and memory resources on a single card form factor.

The application-specific integrated circuit package 148A is shown in expanded detail in FIG. 2. The application-specific integrated circuit package 148A comprises chiplets 150A, 150B, 150C. Each application-specific integrated circuit package 148A, 148B may contain two or more chiplets, of which the chiplets 150A, 150B, 150C are representative. The number of chiplets 150A, 150B, 150C per application-specific integrated circuit package 148A, 148B can be varied across product configurations. The application-specific integrated circuit package 148B has a similar internal structure to the application-specific integrated circuit package 148A, with corresponding chiplets and memory channels.

The chiplet 150A is shown in expanded detail in FIG. 2, revealing the internal components of the chiplet 150A. The chiplet 150A integrates the processing core 152, the Peripheral Component Interconnect Express interface 154, and the plurality of memory channels 156. In one embodiment, each chiplet 150A, 150B, 150C is fabricated in a twelve-nanometer semiconductor process, which provides a favorable balance of transistor density, power efficiency, and manufacturing cost for the memory-controller-heavy design of the chiplet 150A. The die area of each chiplet 150A, 150B, 150C is small relative to a full GPU die, enabling commodity-scale production volumes.

The processing core 152 is the processing element within the chiplet 150A that executes the attention calculations 112 (FIG. 1) against the key-value cache 110 (FIG. 1) stored in the second memory 118A, 118B. The processing core 152 is optimized for the memory-bound matrix multiplication operations involved in the attention calculations 112 (FIG. 1). Unlike the matrix engines on a first accelerator card 102 (FIG. 1), which are optimized for peak floating-point throughput in compute-bound workloads, the processing core 152 is designed to sustain high throughput when the bottleneck is memory bandwidth rather than arithmetic capacity. The processing core 152 provides efficient access to second memory 118A, 118B through the plurality of memory channels 156, enabling the processing core 152 to keep the attention calculations 112 (FIG. 1) fed with data from the key-value cache 110 (FIG. 1) without stalling on memory latency.

The Peripheral Component Interconnect Express interface 154 within the chiplet 150A provides a high-speed data path for communication between the second accelerator card 108 and external devices, including the one or more first accelerator cards 102 (FIG. 1). In one embodiment, the Peripheral Component Interconnect Express interface 154 is a PCIe Generation 5 by sixteen lane (Gen5 x16) interface. The PCIe Gen5 x16 link provides sufficient bandwidth to transfer the intermediate activation vectors 120 (FIG. 1) between the first accelerator card 102 (FIG. 1) and the second accelerator card 108 with minimal latency during each decode iteration. The Peripheral Component Interconnect Express interface 154 within each chiplet 150A, 150B, 150C may be independently addressable, allowing different chiplets 150A, 150B, 150C within the same application-specific integrated circuit package 148A to communicate with different external devices or to share a common upstream link through a PCIe switch.

The plurality of memory channels 156 within the chiplet 150A connect the processing core 152 to the second memory 118A, 118B. In one embodiment, each chiplet 150A, 150B, 150C includes four LPDDR5 memory channels 156. Each memory channel 156 connects to an off-chip LPDDR5 module through a dedicated memory controller integrated into the chiplet 150A. The LPDDR5 modules are sourced from commodity DRAM vendors, taking advantage of the high production volumes and competitive pricing of the consumer and mobile memory markets. The four memory channels 156 per chiplet 150A provide aggregate memory bandwidth that is matched to the throughput of the processing core 152, ensuring that the attention calculations 112 (FIG. 1) are not starved for data. With multiple chiplets 150A, 150B, 150C per application-specific integrated circuit package 148A and multiple application-specific integrated circuit packages 148A, 148B per second accelerator card 108, the combined capacity of second memory 118A, 118B on the second accelerator card 108 may reach hundreds of gigabytes, providing dedicated key-value cache 110 (FIG. 1) storage that is several orders of magnitude larger and cheaper per gigabyte than the first memory 132 (FIG. 1) available on the first accelerator card 102 (FIG. 1).

The second memory 118A is connected to the application-specific integrated circuit package 148A, and the second memory 118B is connected to the application-specific integrated circuit package 148B. Each of the second memory 118A, 118B provides off-chip memory capacity for storing the key-value cache 110 (FIG. 1). The second memory 118A and the second memory 118B may each comprise one or more LPDDR5 modules mounted on the same PCB as the application-specific integrated circuit packages 148A, 148B. In an alternative embodiment, the second memory 118A and the second memory 118B comprise DDR modules connected through standard memory interfaces. In either case, the combined capacity of second memory 118A, 118B on the second accelerator card 108 is substantially greater and less expensive per gigabyte than the first memory 132 (FIG. 1) on the first accelerator card 102 (FIG. 1).

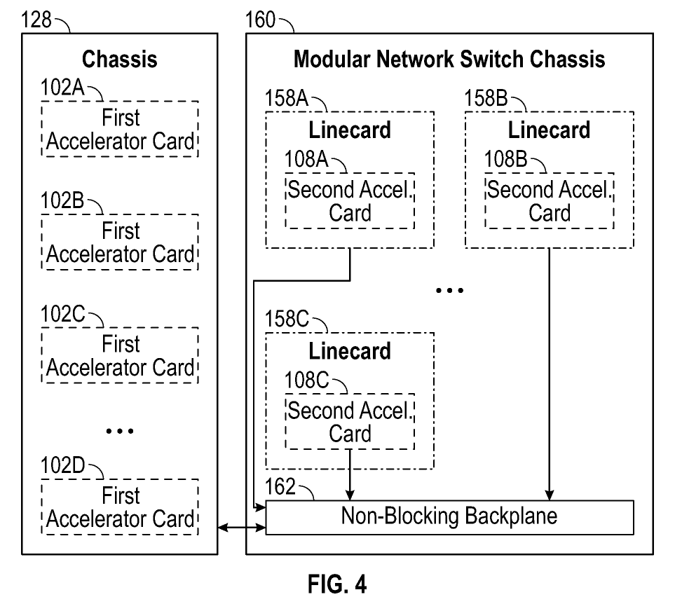

The chiplet-based design of the application-specific integrated circuit packages 148A, 148B achieves economies of scale in second memory 118A, 118B provisioning while enabling future form factors. Because each chiplet 150A, 150B, 150C is a self-contained unit with the processing core 152, the Peripheral Component Interconnect Express interface 154, and the plurality of memory channels 156, the same chiplet design can be used in multiple card configurations. A second accelerator card 108 for datacenter deployment may incorporate four application-specific integrated circuit packages with two chiplets each. The modular nature of the chiplet-based architecture also enables the second accelerator card 108 to be configured as a linecard 158A (FIG. 4) mountable in a modular network switch chassis 160 (FIG. 4), as further described with reference to FIG. 4.

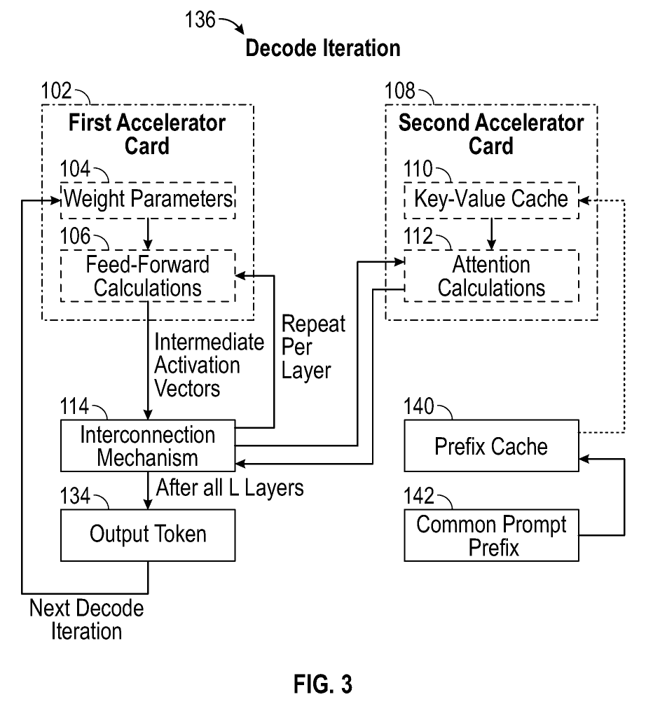

Referring now to FIG. 3, a decode iteration 136 is shown. The system 100 (FIG. 1) iteratively executes the decode iteration 136 for each output token 134 of the Large Language Model 116 (FIG. 1). Each decode iteration 136 represents a single cycle of the autoregressive token generation loop in which the system 100 (FIG. 1) performs the feed-forward calculations 106, the attention calculations 112, and a transfer of the intermediate activation vectors 120 via the interconnection mechanism 114. The decode iteration 136 is bounded by a dashed outer container in FIG. 3, indicating that the entire set of operations within the container repeats once per output token 134.

The decode iteration 136 comprises the first accelerator card 102 on a left side and the second accelerator card 108 on a right side. Within the first accelerator card 102, the weight parameters 104 feed the feed-forward calculations 106. The feed-forward calculations 106 process the input through the linear layers and non-linear activations of each Transformer block using the weight parameters 104, producing a partial result that includes the intermediate activation vectors 120. The arrows in FIG. 3 from the weight parameters 104 downward to the feed-forward calculations 106 indicate that the weight parameters 104 are consumed by the feed-forward calculations 106 during each layer of the decode iteration 136.

Within the second accelerator card 108, the key-value cache 110 feeds the attention calculations 112. The attention calculations 112 compute scaled dot-product attention against the query, key, and value tensors stored in the key-value cache 110. For each Transformer layer, the attention calculations 112 read the accumulated key and value tensors for the current session from the key-value cache 110, compute the attention scores by multiplying the query vector against all stored key vectors, apply softmax normalization, and multiply the resulting attention weights against the stored value vectors to produce the attention output for that layer. The arrows in FIG. 3 from the key-value cache 110 downward to the attention calculations 112 indicate that the key-value cache 110 is consumed by the attention calculations 112 during each layer.

The interconnection mechanism 114, shown in FIG. 3 between the first accelerator card 102 and the second accelerator card 108, carries the intermediate activation vectors 120 bidirectionally. During each decode iteration 136, the processing within each Transformer layer proceeds as follows. The first accelerator card 102 performs the feed-forward calculations 106 for one sub-stage of a given layer. The output of the feed-forward calculations 106 is transferred as an intermediate activation vector 120 through the interconnection mechanism 114 to the second accelerator card 108. The second accelerator card 108 then performs the attention calculations 112 for the corresponding sub-stage, processing the intermediate activation vector 120 against the key-value cache 110. The result of the attention calculations 112 is transferred as an intermediate activation vector 120 back through the interconnection mechanism 114 to the first accelerator card 102 for the next layer. Each Transformer block of the Large Language Model 116 (FIG. 1) comprises both an attention sub-stage and a feed-forward sub-stage; the ordering of the two sub-stages within a block may vary across model architectures, and the foregoing description is not limited to a particular sub-stage execution order. For a model with eighty Transformer blocks, such as a seventy-billion-parameter model, the decode iteration 136 sequences through all eighty layers, with the intermediate activation vectors 120 traversing the interconnection mechanism 114 at each layer boundary. Because each traversal involves only kilobytes of activation data rather than gigabytes of key-value cache data, the aggregate bandwidth consumed over all eighty layer crossings remains well within the capacity of the interconnection mechanism 114.

The deterministic split, with the weight parameters 104 and the feed-forward calculations 106 on the first accelerator card 102, and the key-value cache 110 and the attention calculations 112 on the second accelerator card 108, ensures that compute-bound operations exploit the matrix engines of the first accelerator card 102 while memory-bound attention paths remain adjacent to the inexpensive second memory 118 (FIG. 2) on the second accelerator card 108. In some embodiments, the key-value cache 110 remains resident on the second accelerator card 108 and does not traverse the interconnection mechanism 114, reducing inter-device bandwidth requirements by roughly two orders of magnitude relative to architectures that stream the key-value cache 110 for every decode step. In these embodiments, the interconnection mechanism 114 carries only the intermediate activation vectors 120 and control signals, not bulk cache data.

The decode iteration 136 produces the output token 134. The output token 134 is generated based on results of the feed-forward calculations 106 and the attention calculations 112 after the final Transformer layer completes. A language model head, which may reside on the first accelerator card 102, converts the final hidden state into a probability distribution over the vocabulary, and the output token 134 is selected from the probability distribution by sampling or by selecting the highest-probability token. After producing the output token 134, the system 100 (FIG. 1) loops back to the beginning of the decode iteration 136 for another cycle, as indicated by the loop-back path shown in FIG. 3. Each output token 134 is appended to the context and the corresponding key and value vectors are appended to the key-value cache 110 on the second accelerator card 108, extending the cached state for the session. The decode iteration 136 repeats until a stop condition is reached, such as generation of an end-of-sequence token or reaching a maximum token count.

At each decode iteration 136, the first accelerator card 102 processes the token through all eighty Transformer layers in approximately fifty milliseconds per token in one embodiment. The time per output token 134 is dominated by the latency of the intermediate activation vector 120 transfers across the interconnection mechanism 114 and by the memory read bandwidth of the second memory 118 (FIG. 2) on the second accelerator card 108 during the attention calculations 112. By co-locating the key-value cache 110 with the processing core 152 (FIG. 2) that executes the attention calculations 112, the system 100 (FIG. 1) eliminates the need for any bulk data movement of the key-value cache 110, and the per-token latency of the decode iteration 136 remains bounded regardless of the size of the key-value cache 110 or the number of concurrent sessions.

The second accelerator card 108 stores a prefix cache 140 representing a shared initial key-value cache 110 state computed from a common prompt prefix 142. The common prompt prefix 142 is a shared initial portion of a prompt, such as system instructions, few-shot examples, or common retrieval-augmented generation context, that is identical across multiple concurrent inference sessions. In applications such as enterprise retrieval-augmented generation, document summarization, and knowledge-based query platforms, a substantial portion of the prompt is shared across all user queries. In one embodiment, the common prompt prefix 142 may comprise seventy-two thousand tokens, equivalent to approximately two hundred pages of text, producing a prefix cache 140 of approximately twenty-four gigabytes.

On a conventional GPU, prefilling a seventy-two-thousand-token common prompt prefix 142 requires processing all seventy-two thousand tokens through every Transformer layer of the Large Language Model 116 (FIG. 1). Internal benchmarks demonstrate that prefilling a seventy-two-thousand-token common prompt prefix 142 on a current-generation GPU takes approximately thirty seconds, far exceeding acceptable time-to-first-token latency budgets for interactive applications, which typically require sub-second response times. The prefix cache 140 eliminates the need to repeat the prefill computation for each new session that shares the common prompt prefix 142.

The prefix cache 140 is shared across multiple concurrent inference sessions without recomputation. When a new session begins, the system 100 (FIG. 1) initializes the key-value cache 110 for that session by copying or referencing the prefix cache 140 as the initial state, and then computes only the incremental key and value vectors for the tokens that are unique to that session beyond the common prompt prefix 142. The key-value caches 110 for different sessions then diverge from the prefix cache 140 based on additional prefill and decode tokens unique to each session. By storing the prefix cache 140 locally on the second accelerator card 108 in the second memory 118 (FIG. 2), the system 100 (FIG. 1) amortizes the cost of computing the common prompt prefix 142 across millions of concurrent sessions, reducing time-to-first-token to under six hundred milliseconds and preserving throughput on the first accelerator card 102 for the feed-forward calculations 106. Prefix caching and large context windows result in key-value cache 110 sizes that are substantially larger than 2.7 gigabytes per session and cannot be recomputed for each session due to the time-to-first-token requirements. Furthermore, reasoning-centric models that generate intermediate reasoning tokens produce even larger key-value caches 110 per session. The expansive second memory 118 (FIG. 2) on the second accelerator card 108 readily accommodates the enlarged key-value caches 110 without requiring eviction or tiering.

As a second worked example, a reasoning-centric model such as a DeepSeek-V3 architecture augmented with reasoning capabilities with an embedding size of 7162, sixty-one Transformer layers, one hundred twenty-eight attention heads, two hundred fifty-six experts per token, and approximately 1.35 terabytes of parameter storage generates a key-value cache 110 of approximately 1.125 gigabytes per session. Because the reasoning model produces intermediate reasoning tokens in addition to output tokens, the effective key-value cache 110 per session grows substantially larger than the chatbot example described above, further reinforcing the advantage of storing the key-value cache 110 on the second accelerator card 108 in the expansive second memory 118 (FIG. 2) rather than in the constrained first memory 132 (FIG. 1) on the first accelerator card 102.

As shown in FIG. 4, the one or more first accelerator cards 102A, 102B, 102C, 102D and the one or more second accelerator cards 108A, 108B, 108C are installed in physically separate chassis 128. The first accelerator cards 102A, 102B, 102C, 102D are installed in a chassis 128 on a left side of FIG. 4. Additional first accelerator cards may be installed in the chassis 128, as indicated by the ellipsis between the first accelerator card 102C and the first accelerator card 102D. The chassis 128 may be a standard datacenter rack enclosure, such as a four-rack-unit (4RU) enclosure equipped with PCIe slots for accelerator cards. In one embodiment, the chassis 128 accommodates up to sixteen PCIe slots for first accelerator cards 102A, 102B, 102C, 102D and any additional GPU cards. The chassis 128 may be an existing datacenter asset that operators have already deployed for conventional GPU-based inference workloads, enabling the system 100 (FIG. 1) to reuse installed GPU infrastructure without modification.

The one or more second accelerator cards 108A, 108B, 108C are configured as linecards 158A, 158B, 158C mountable in a modular network switch chassis 160. The linecard 158A contains the second accelerator card 108A. The linecard 158B contains the second accelerator card 108B. The linecard 158C contains the second accelerator card 108C. Additional linecards may be installed in the modular network switch chassis 160, as indicated by the ellipsis between the linecard 158B and the linecard 158C. Each linecard 158A, 158B, 158C is a pluggable module that can be inserted into or removed from the modular network switch chassis 160 independently, without requiring the modular network switch chassis 160 to be powered down or reconfigured. The linecard form factor leverages existing modular network switch and router chassis designs commonly used in datacenter networking infrastructure, enabling operators to deploy second accelerator cards 108A, 108B, 108C in standard networking equipment bays rather than requiring dedicated server enclosures.

The modular network switch chassis 160 provides a non-blocking backplane 162 for communication between the one or more second accelerator cards 108A, 108B, 108C and the one or more first accelerator cards 102A, 102B, 102C, 102D. The non-blocking backplane 162 connects the linecards 158A, 158B, 158C to one another and to external devices, including the chassis 128 containing the one or more first accelerator cards 102A, 102B, 102C, 102D. The non-blocking backplane 162 provides any-to-any communication between the linecards 158A, 158B, 158C without contention, meaning that simultaneous data transfers between different pairs of linecards 158A, 158B, 158C do not interfere with one another. The non-blocking characteristic of the non-blocking backplane 162 ensures that the attention calculations 112 (FIG. 1) on different second accelerator cards 108A, 108B, 108C, which serve different concurrent sessions, all receive intermediate activation vectors 120 (FIG. 1) from the first accelerator cards 102A, 102B, 102C, 102D without queuing delays. The modular network switch chassis 160 may be, for example, a chassis conforming to modular network switch or router form factors used in datacenter networking, such as a Cisco Nexus-class chassis or an equivalent platform from another networking vendor that provides non-blocking, any-to-any fabric connectivity.

The linecard form factor of the linecards 158A, 158B, 158C enables operators to incrementally add second accelerator cards 108A, 108B, 108C to meet growing key-value cache 110 (FIG. 1) requirements without disrupting existing GPU infrastructure in the chassis 128. A number of the one or more second accelerator cards 108A, 108B, 108C is independently scalable from a number of the one or more first accelerator cards 102A, 102B, 102C, 102D. Adding second accelerator cards 108A, 108B, 108C to increase key-value cache 110 (FIG. 1) capacity requires no modification to the existing first accelerator cards 102A, 102B, 102C, 102D in the chassis 128, and adding first accelerator cards 102A, 102B, 102C, 102D to increase compute capacity requires no modification to the existing second accelerator cards 108A, 108B, 108C in the modular network switch chassis 160. The independent scalability enables operators to right-size each resource dimension to the workload. A chatbot application that serves a large number of concurrent sessions with moderate context lengths may require many second accelerator cards 108A, 108B, 108C relative to first accelerator cards 102A, 102B, 102C, 102D, while a document summarization application with fewer concurrent sessions but longer context windows may require a different ratio. The ability to adjust the NPU-to-GPU ratio without replacing existing hardware reduces capital expenditure and simplifies capacity planning.

In an alternative deployment, the first accelerator cards 102A, 102B, 102C, 102D and the second accelerator cards 108A, 108B, 108C are installed in separate standard server chassis within the same datacenter rack, connected via a shared PCIe backplane or via top-of-rack Ethernet or InfiniBand switches. In yet another deployment, the first accelerator cards 102A, 102B, 102C, 102D are located in a first datacenter rack and the second accelerator cards 108A, 108B, 108C are located in a second datacenter rack, connected by Ethernet or InfiniBand links that span the inter-rack distance. The choice of deployment topology depends on the latency budget, bandwidth requirements, and physical constraints of the datacenter. In some embodiments employing any of these topologies, the key-value cache 110 (FIG. 1) remains resident on the second accelerator cards 108A, 108B, 108C in the respective linecards 158A, 158B, 158C or server slots, and the intermediate activation vectors 120 (FIG. 1), which are compact, traverse the interconnection between the chassis 128 and the modular network switch chassis 160 or between separate racks.

Referring now to FIG. 5, an inference framework 138 is shown. The inference framework 138 is a software framework for managing Large Language Model inference workloads. In one embodiment, the inference framework 138 is an open-source inference framework such as vLLM, TensorRT-LLM, SGLang, or an equivalent serving platform. A software abstraction layer 130 is integrated with the inference framework 138. The software abstraction layer 130 is configured to distribute workload between the one or more first accelerator cards 102A, 102B and the one or more second accelerator cards 108. By integrating the software abstraction layer 130 with the inference framework rather than as a standalone runtime, the system 100 (FIG. 1) can leverage the existing scheduling, batching, and memory management capabilities of the inference framework 138 while adding the disaggregated compute-memory architecture without requiring operators to adopt an entirely new software stack.

The software abstraction layer 130 manages workload distribution between the one or more first accelerator cards 102A, 102B and the second accelerator card 108. The software abstraction layer 130 provides heterogeneous device support, enabling the system 100 (FIG. 1) to use first accelerator cards 102A, 102B concurrently even when they are from different vendors or different generations. For example, the first accelerator card 102A may be an NVIDIA A100 from a first generation, and the first accelerator card 102B may be an NVIDIA H100 from a second generation, the first accelerator card 102A may be from a Blackwell-class generation, or the first accelerator card 102A may be from NVIDIA and the first accelerator card 102B may be from AMD, such as an AMD MI325X. The software abstraction layer 130 decouples model placement from a specific first accelerator card type by providing a uniform interface through which the inference framework 138 dispatches feed-forward calculations 106 (FIG. 1) to whichever first accelerator cards 102A, 102B are available, regardless of the vendor or generation of those first accelerator cards 102A, 102B. As a result, operators can deploy mixed fleets of first accelerator cards 102A, 102B from different vendors or different generations alongside the second accelerator card 108, enabling graceful capacity expansion while preserving software compatibility. When a new generation of first accelerator card becomes available, operators can add the new first accelerator cards to the existing fleet without retiring older first accelerator cards and without recompiling or reconfiguring the Large Language Model 116 (FIG. 1). The software abstraction layer 130 handles the differences in memory capacity, instruction set, and driver interface between first accelerator cards 102A, 102B of different vendors or generations.

The interconnection mechanism 114, previously described with reference to FIGS. 1 and 3, comprises at least one of a Peripheral Component Interconnect Express bus 122, an Ethernet network 124, or an InfiniBand network 126. The Peripheral Component Interconnect Express bus 122, the Ethernet network 124, and the InfiniBand network 126 are shown as alternative interconnection subtypes in FIG. 5, indicated by "OR" labels between the Peripheral Component Interconnect Express bus 122 and the Ethernet network 124, and between the Ethernet network 124 and the InfiniBand network 126.

The Peripheral Component Interconnect Express bus 122 provides a high-speed fabric within a shared chassis, such as when the one or more first accelerator cards 102A, 102B and the second accelerator card 108 are installed in the same rack enclosure or connected through a common PCIe backplane. In one embodiment, the Peripheral Component Interconnect Express bus 122 is a PCIe Gen5 x16 bus. The Peripheral Component Interconnect Express bus 122 provides the lowest latency of the three interconnection subtypes and is suited for deployments where the first accelerator cards 102A, 102B and the second accelerator card 108 are in close physical proximity.

The Ethernet network 124 provides connectivity across separate chassis and across multiple racks in a datacenter. The Ethernet network 124 may use protocols such as Transmission Control Protocol/Internet Protocol (TCP/IP), Remote Direct Memory Access (RDMA), or RDMA over Converged Ethernet (RoCE). In one embodiment, the Ethernet network 124 uses RoCE to provide low-latency, high-throughput transfers of the intermediate activation vectors 120 (FIG. 1) between the first accelerator cards 102A, 102B in a first chassis and the second accelerator card 108 in a second chassis. The Ethernet network 124 enables the system 100 (FIG. 1) to scale across multiple racks using standard datacenter Ethernet infrastructure, including existing Layer 2/Layer 3 switches, without requiring specialized interconnect hardware.

The InfiniBand network 126 provides high-bandwidth, low-latency connectivity suited to multi-rack or geographically distributed datacenter deployments. The InfiniBand network 126 provides native RDMA support and deterministic latency characteristics, making the InfiniBand network 126 well suited for deployments where the intermediate activation vectors 120 (FIG. 1) traverse multiple network hops between the first accelerator cards 102A, 102B and the second accelerator card 108. The selection among the Peripheral Component Interconnect Express bus 122, the Ethernet network 124, and the InfiniBand network 126 depends on the physical deployment topology and latency requirements of the system 100 (FIG. 1). In some deployments, multiple interconnection subtypes may be used concurrently; for example, the Peripheral Component Interconnect Express bus 122 may connect first accelerator cards 102A, 102B and second accelerator cards 108 within a single chassis, while the Ethernet network 124 or the InfiniBand network 126 connects chassis across different racks.

The arrows in FIG. 5 from the software abstraction layer 130 to the first accelerator cards 102A, 102B and the second accelerator card 108 indicate that the software abstraction layer 130 directs workload placement to each hardware resource. The arrows from the first accelerator cards 102A, 102B and the second accelerator card 108 to the interconnection mechanism 114 indicate that the intermediate activation vectors 120 (FIG. 1) flow through the interconnection mechanism 114 during each decode iteration 136 (FIG. 3). The software abstraction layer 130 coordinates the timing of the intermediate activation vector 120 (FIG. 1) transfers to ensure that the feed-forward calculations 106 (FIG. 1) on the first accelerator cards 102A, 102B and the attention calculations 112 (FIG. 1) on the second accelerator card 108 are properly sequenced through each Transformer layer of the decode iteration 136 (FIG. 3).

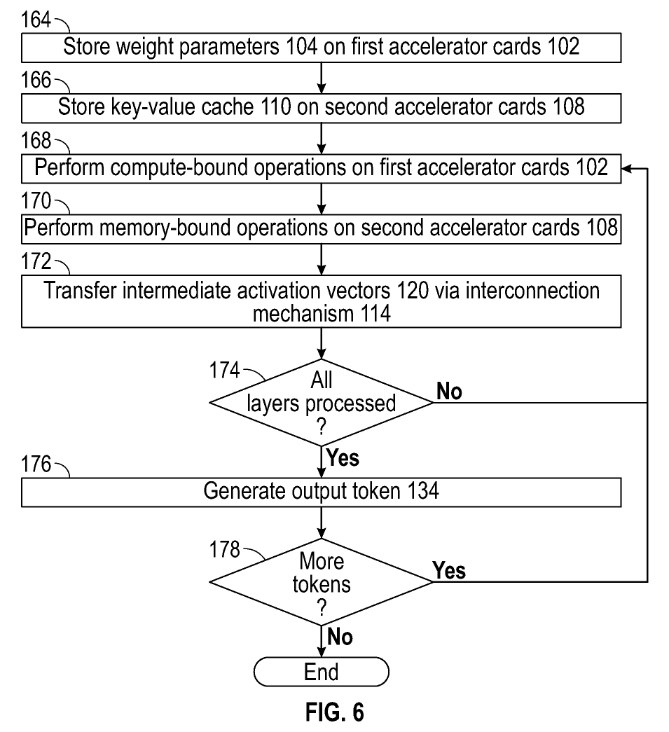

Referring now to FIG. 6, a method for serving the Large Language Model 116 (FIG. 1) is shown. The method begins at step 164, in which the weight parameters 104 (FIG. 1) of the Large Language Model 116 (FIG. 1) are stored on the one or more first accelerator cards 102 (FIG. 1). The weight parameters 104 (FIG. 1) are loaded into the first memory 132 (FIG. 1) on each first accelerator card 102 (FIG. 1), where the weight parameters 104 (FIG. 1) remain resident across all inference sessions served by the system 100 (FIG. 1). When the weight parameters 104 (FIG. 1) exceed the capacity available on the first accelerator card 102 (FIG. 1), the weight parameters 104 (FIG. 1) may be distributed across multiple first accelerator cards 102 (FIG. 1) using tensor parallel or pipeline parallel techniques.

At step 166, the key-value cache 110 (FIG. 1) is stored on the one or more second accelerator cards 108 (FIG. 1) that are physically separate from the one or more first accelerator cards 102 (FIG. 1). Each second accelerator card 108 (FIG. 1) allocates a portion of the second memory 118 (FIG. 2) for the key-value cache 110 (FIG. 1) corresponding to one or more active inference sessions. Because the key-value cache 110 (FIG. 1) resides on the second accelerator cards 108 (FIG. 1) rather than in the first memory 132 (FIG. 1) on the first accelerator cards 102 (FIG. 1), the system 100 (FIG. 1) avoids the eviction and recomputation penalties that arise in conventional architectures when the first memory 132 (FIG. 1) is exhausted.

At step 168, the feed-forward calculations 106 (FIG. 1) are performed on the one or more first accelerator cards 102 (FIG. 1) using the weight parameters 104 (FIG. 1). The feed-forward calculations 106 (FIG. 1) process the input through the linear layers and non-linear activations of each Transformer block, producing a partial result that includes the intermediate activation vectors 120 (FIG. 1).

At step 170, the attention calculations 112 (FIG. 1) are performed on the one or more second accelerator cards 108 (FIG. 1) using the key-value cache 110 (FIG. 1). For each Transformer layer, the attention calculations 112 (FIG. 1) read the accumulated key and value tensors for the current session from the key-value cache 110 (FIG. 1), compute scaled dot-product attention, and produce the attention output for that layer.

At step 172, the intermediate activation vectors 120 (FIG. 1) are transferred between the one or more first accelerator cards 102 (FIG. 1) and the one or more second accelerator cards 108 (FIG. 1) via the interconnection mechanism 114 (FIG. 1). The key-value cache 110 (FIG. 1) remains resident on the one or more second accelerator cards 108 (FIG. 1) and does not traverse the interconnection mechanism 114 (FIG. 1). Because the intermediate activation vectors 120 (FIG. 1) are compact relative to the key-value cache 110 (FIG. 1), the bandwidth consumed on the interconnection mechanism 114 (FIG. 1) remains modest even when the method sequences through all Transformer layers.

At decision step 174, the method determines whether all Transformer layers of the Large Language Model 116 (FIG. 1) have been processed for the current output token. If additional layers remain, the method returns to step 168 to perform the feed-forward calculations 106 (FIG. 1) and attention calculations 112 (FIG. 1) for the next Transformer layer, repeating steps 168, 170, and 172 for each successive layer. For a model with eighty Transformer layers, steps 168, 170, and 172 are repeated eighty times per output token, with the intermediate activation vectors 120 (FIG. 1) traversing the interconnection mechanism 114 (FIG. 1) at each layer boundary. If all Transformer layers have been processed, the method proceeds to step 176.

At step 176, the output token 134 (FIG. 3) is generated based on results of the feed-forward calculations 106 (FIG. 1) and the attention calculations 112 (FIG. 1) after the final Transformer layer completes. A language model head converts the final hidden state into a probability distribution over the vocabulary, and the output token 134 (FIG. 3) is selected from the probability distribution.

At decision step 178, the method determines whether more tokens are to be generated. If more tokens are to be generated, the method returns to step 168 to perform another decode iteration 136 (FIG. 3), in which the feed-forward calculations 106 (FIG. 1), the attention calculations 112 (FIG. 1), and the transfer of the intermediate activation vectors 120 (FIG. 1) repeat to generate output token 134 (FIG. 3). Each output token 134 (FIG. 3) extends the key-value cache 110 (FIG. 1) on the second accelerator card 108 (FIG. 1) with the corresponding key and value vectors. The method continues until a stop condition is reached, such as generation of an end-of-sequence token or reaching a maximum token count. If no more tokens are to be generated, the method ends.

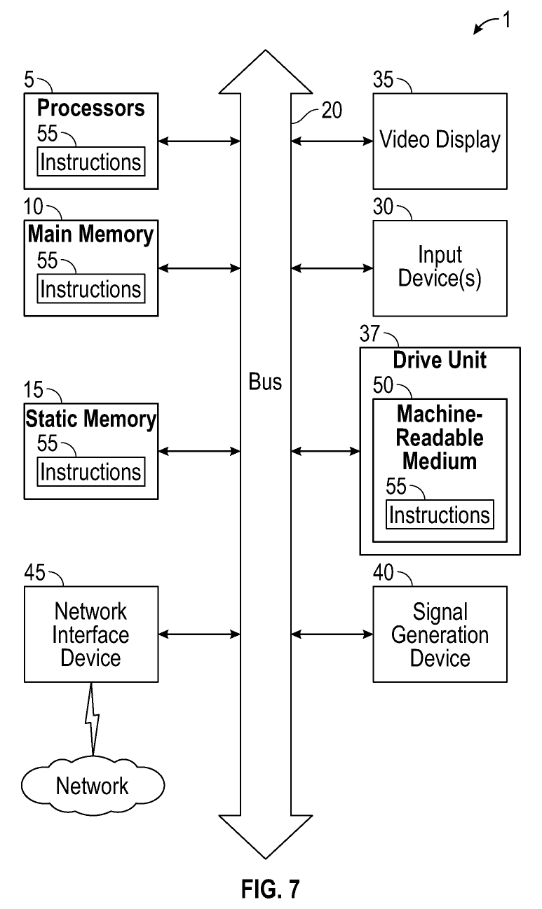

FIG. 7 is a diagrammatic representation of an example machine in the form of a computer system 1, within which a set of instructions for causing the machine to perform any one or more of the methodologies discussed herein may be executed. In various example embodiments, the machine operates as a standalone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a personal digital assistant (PDA), a cellular telephone, a portable music player (e.g., a portable hard drive audio device such as a Moving Picture Experts Group Audio Layer 3 (MP3) player), a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The computer system 1 includes a processor or multiple processor(s) 5 (e.g., a central processing unit (CPU), a graphics processing unit (GPU), or both), and a main memory 10 and static memory 15, which communicate with each other via a bus 20. The computer system 1 may further include a video display 35 (e.g., a liquid crystal display (LCD)). The computer system 1 may also include an alpha-numeric input device(s) 30 (e.g., a keyboard), a cursor control device (e.g., a mouse), a voice recognition or biometric verification unit (not shown), a drive unit 37 (also referred to as disk drive unit), a signal generation device 40 (e.g., a speaker), and a network interface device 45. The computer system 1 may further include a data encryption module (not shown) to encrypt data.

The drive unit 37 includes a computer or machine-readable medium 50 on which is stored one or more sets of instructions and data structures (e.g., instructions 55) embodying or utilizing any one or more of the methodologies or functions described herein. The instructions 55 may also reside, completely or at least partially, within the main memory 10 and/or within the processor(s) 5 during execution thereof by the computer system 1. The main memory 10 and the processor(s) 5 may also constitute machine-readable media.

The instructions 55 may further be transmitted or received over a network via the network interface device 45 utilizing any one of a number of well-known transfer protocols (e.g., Hyper Text Transfer Protocol (HTTP)). While the machine-readable medium 50 is shown in an example embodiment to be a single medium, the term "computer-readable medium" should be taken to include a single medium or multiple media (e.g., a centralized or distributed database and/or associated caches and servers) that store the one or more sets of instructions. The term "computer-readable medium" shall also be taken to include any medium that is capable of storing, encoding, or carrying a set of instructions for execution by the machine and that causes the machine to perform any one or more of the methodologies of the present application, or that is capable of storing, encoding, or carrying data structures utilized by or associated with such a set of instructions. The term "computer-readable medium" shall accordingly be taken to include, but not be limited to, solid-state memories, optical and magnetic media, and carrier wave signals. Such media may also include, without limitation, hard disks, floppy disks, flash memory cards, digital video disks, random access memory (RAM), read only memory (ROM), and the like. The example embodiments described herein may be implemented in an operating environment comprising software installed on a computer, in hardware, or in a combination of software and hardware.

Where appropriate, the functions described herein can be performed in one or more of hardware, software, firmware, digital components, or analog components. For example, the encoding and or decoding systems can be embodied as one or more application specific integrated circuits (ASICs) or microcontrollers that can be programmed to carry out one or more of the systems and procedures described herein. Certain terms are used throughout the description and claims refer to particular system components. As one skilled in the art will appreciate, components may be referred to by different names. This document does not intend to distinguish between components that differ in name, but not function.

One skilled in the art will recognize that the Internet service may be configured to provide Internet access to one or more computing devices that are coupled to the Internet service, and that the computing devices may include one or more processors, buses, memory devices, display devices, input/output devices, and the like. Furthermore, those skilled in the art may appreciate that the Internet service may be coupled to one or more databases, repositories, servers, and the like, which may be utilized in order to implement any of the embodiments of the disclosure as described herein.

What is claimed is:

1. A system for serving a large language model, the system comprising:
one or more first accelerator cards configured to store weight parameters of the large language model in a first memory and to perform compute-bound operations of the large language model;
one or more second accelerator cards, physically separate from the one or more first accelerator cards, configured to store session-specific state including a key-value cache in a second memory distinct from the first memory and to perform memory-bound operations of the large language model; and
an interconnection mechanism connecting the one or more first accelerator cards and the one or more second accelerator cards.

2. The system of claim 1, wherein the one or more second accelerator cards store the session-specific state in commodity double data rate (DDR) dynamic random-access memory having a lower cost per byte than the first memory.

3. The system of claim 1, wherein only intermediate activation vectors are transferred between the one or more first accelerator cards and the one or more second accelerator cards via the interconnection mechanism, and wherein the session-specific state remains resident on the one or more second accelerator cards.

4. The system of claim 1, wherein the interconnection mechanism comprises at least one of: a Peripheral Component Interconnect Express bus, an Ethernet network, or an InfiniBand network.

5. The system of claim 1, wherein the one or more first accelerator cards and the one or more second accelerator cards are installed in physically separate chassis.

6. The system of claim 1, further comprising a software abstraction layer, wherein the one or more first accelerator cards comprise accelerator cards from different vendors or different generations, and wherein the software abstraction layer decouples model placement from a specific accelerator card type.

7. The system of claim 1, wherein a number of the one or more second accelerator cards is independently scalable from a number of the one or more first accelerator cards.

8. The system of claim 1, wherein the one or more first accelerator cards comprise one or more graphics processing unit cards, and the one or more second accelerator cards comprise one or more neural processing unit cards.

9. The system of claim 1, wherein the compute-bound operations comprise feed-forward calculations and query-key-value projection layers, and the memory-bound operations comprise attention calculations.

10. The system of claim 1, wherein the compute-bound operations require memory that is shared across all concurrent user sessions and does not scale with a number of concurrent user sessions, and the memory-bound operations require session-specific state that scales with the number of concurrent user sessions.

11. A system comprising:
one or more first accelerator cards, each first accelerator card comprising a first memory storing weight parameters of a large language model;
one or more second accelerator cards, physically separate from the one or more first accelerator cards, each second accelerator card comprising a second memory, distinct from the first memory, storing session-specific state including a key-value cache; and
an interconnection mechanism connecting the one or more first accelerator cards and the one or more second accelerator cards and configured to transfer intermediate activation vectors between the one or more first accelerator cards and the one or more second accelerator cards, where the one or more first accelerator cards are configured to perform compute-bound operations using the weight parameters, and the one or more second accelerator cards are configured to perform memory-bound operations using the session-specific state.

12. The system of claim 11, wherein the system iteratively executes, for each output token of the large language model: the compute-bound operations on the one or more first accelerator cards, the memory-bound operations on the one or more second accelerator cards, and a transfer of the intermediate activation vectors via the interconnection mechanism.

13. The system of claim 11, further comprising a software abstraction layer integrated with an inference framework, the software abstraction layer configured to distribute workload between the one or more first accelerator cards and the one or more second accelerator cards.

14. The system of claim 11, wherein storing the session-specific state on the one or more second accelerator cards eliminates eviction and recomputation of the key-value cache as a number of concurrent inference sessions increases.

15. The system of claim 11, wherein the one or more second accelerator cards store a prefix cache representing a shared initial key-value cache state computed from a common prompt prefix, the prefix cache being shared across multiple concurrent inference sessions without recomputation.

16. A method for serving a large language model, the method comprising:
storing weight parameters of the large language model on one or more first accelerator cards;
storing session-specific state including a key-value cache on one or more second accelerator cards physically separate from the one or more first accelerator cards;
performing compute-bound operations of the large language model on the one or more first accelerator cards using the weight parameters;
performing memory-bound operations of the large language model on the one or more second accelerator cards using the session-specific state; and
transferring intermediate activation vectors between the one or more first accelerator cards and the one or more second accelerator cards via an interconnection mechanism, where the session-specific state remains resident on the one or more second accelerator cards.

17. The method of claim 16, further comprising iteratively executing, for each output token of the large language model: the performing of the compute-bound operations, the performing of the memory-bound operations, and the transferring of the intermediate activation vectors, and generating the output token based on results of the compute-bound operations and the memory-bound operations.

18. The method of claim 16, further comprising distributing the compute-bound operations and the memory-bound operations across the one or more first accelerator cards and the one or more second accelerator cards via a software abstraction layer, wherein the one or more first accelerator cards comprise accelerator cards from different vendors or different generations.

19. The method of claim 16, further comprising storing a prefix cache on the one or more second accelerator cards, the prefix cache representing a shared initial key-value cache state computed from a common prompt prefix, and sharing the prefix cache across multiple concurrent inference sessions without recomputation.

20. The method of claim 16, wherein each second accelerator card comprises a plurality of application-specific integrated circuit packages, each application-specific integrated circuit
package comprising chiplets that integrate a processing core, a Peripheral Component Interconnect Express interface, and a plurality of memory channels.
